(19) United States
(12) Patent Application Publication
(10) Pub. No.: US 2026/0105381 A1
(43) Pub. Date: Apr. 16, 2026

(54) SYSTEM AND METHOD OF PREDICTING OCCURRENCE OF KEY EVENTS BASED ON OCCURRENCE OF OTHER EVENTS

(71) Applicant: Honeywell International Inc., Charlotte, NC (US)

(72) Inventors: Aishwarya Coffey, Dublin (IE); Sabina Azizli, Fulshear, TX (US); Junda Zhu, Atlanta, GA (US); Sahil Vartak, Atlanta, GA (US); Tarun Mirani, Decatur, GA (US); Rakesh Venuturumilli, Phoenix, AZ (US)

(21) Appl. No.: 18/911,281

(22) Filed: Oct. 10, 2024

(51) Int. Cl. G06N 20/10; G06N 20/20; G08B 31/00

(52) U.S. Cl. CPC G06N 20/10; G06N 20/20; G08B 31/00

(57) ABSTRACT

A system and a method of predicting occurrence of a key event are described. The method includes receiving event data related to a plurality of occurrences of a key event in an environment. Also, control data associated with a plurality of events occurring in the environment is received. The control data is filtered based on the event data to identify a set of events occurring around the start time of the key event. Different occurrences of the key event are paired. Within each pair, sequences of the set of other events occurring during each occurrence of the key event are matched, for identifying one or more longest matching patterns of the plurality of events. A future occurrence is the key event is predicted by determining presence of the one or more longest matching patterns of the plurality of events within a real time stream of control data.

### TECHNICAL FIELD

Present disclosure relates to event prediction, and more specifically relates to event prediction using fuzzy matching and Artificial Intelligence/Machine Learning (AI/ML) techniques.

### BACKGROUND

Undesired events that often result into losses of different kinds are known as adverse events. The losses may include operational losses, financial losses, reputational losses, environmental losses, and health and safety hazards. The adverse event may be natural events like earthquake, flooding, or cyclones or non-natural events related to industrial or residential systems.

For example, unplanned flaring is a non-natural event that involves burning of excessive hydrocarbon stock to get rid of waste gases. Unplanned flaring is performed in emergency situations, such as during equipment failure and power outage. Burning of the hydrocarbon stock during unplanned flaring results into environmental pollution and global warming. Flooding is a natural event that refers to overflow of water onto normally dry land. Flooding can occur due to various factors such as heavy rainfall, storm surges, river overflow, or dam failure. Flooding results into property damage, agricultural losses, and loss of lives. Similarly, there are several other undesired events whose occurrence is required to be prevented or whose impact is required to be minimized to a possible extent.

There is thus a need of a method to beforehand determine occurrence of such events, so that suitable preventive measures could be taken to prevent occurrence of such events or mitigate the resulting losses, at least.

### SUMMARY OF THE INVENTION

In one embodiment, a method of predicting occurrence of key events based on occurrence of other events is described. The method comprises receiving event data related to a plurality of occurrences of a key event in an environment. The event data includes one or more of an occurrence identifier, a start time and an end time of each occurrence of the key event. The method further comprises receiving control data associated with a plurality of events occurring in the environment. The control data includes one or more of timestamps of the plurality of events, source of the plurality of events, priority of the plurality of events, location of occurrence of the plurality of events, operational state of equipment associated with the plurality of events, description of the plurality of events, and values of parameters associated with the plurality of events. The method further comprises filtering the control data based on the event data to identify a set of events occurring around the start time of the key event. The method further comprises matching, within pairs of occurrences of the key event, sequences of the set of events occurring during each occurrence of the key event, for identifying one or more longest matching patterns of the plurality of events. The method further comprises predicting a future occurrence of the key event by determining presence of the one or more longest matching patterns of the plurality of events within a real time stream of control data.

In one aspect, the method further comprises providing an alarm, to an operator, indicating the future occurrence of the key event.

In one aspect, the method further comprises receiving an input, from the operator, for performing one or more operations to prevent the future occurrence of the key event.

In one aspect, the control data is filtered based on a predefined time window associated with the start time of the key event.

In one aspect, the predefined time window has a pre-occurrence time period and a post-occurrence time period associated with the key event.

In one aspect, the method further comprises identifying a predefined number of predominantly occurring events from the one or more longest matching patterns of the plurality of events, and predicting the future occurrence of the key event by determining presence of the predominantly occurring events within the real time stream of control data.

In one aspect, the matching includes creating a scoring matrix by assigning a predefined match score for every match with right position and a predefined penalty score for every gap.

In one aspect, the method further comprises training a data model for determining the presence of the one or more longest matching patterns of the plurality of events within the real time stream of control data.

In one aspect, the data model is trained using one or more machine learning techniques including Naïve Bayes, Random Forest, Decision Trees, Logistic Regression, and Support Vector Machines.

In one aspect, the key event is one of flaring and flooding.

In one embodiment, a system for predicting occurrence of key events based on occurrence of other events is described. The system comprises a processor and a memory storing program instructions which, when executed by the processor, causes the processor to perform several functions. The processor receives event data related to a plurality of occurrences of a key event in an environment. The event data includes one or more of an occurrence identifier, a start time and an end time of each occurrence of the key event. The processor receives control data associated with a plurality of events occurring in the environment. The control data includes one or more of timestamps of the plurality of events, source of the plurality of events, priority of the plurality of events, location of occurrence of the plurality of events, operational state of equipment associated with the plurality of events, description of the plurality of events, and values of parameters associated with the plurality of events. The processor filters the control data based on the event data to identify a set of events occurring around the start time of the key event. The processor matches, within pairs of occurrences of the key event, sequences of the set of events occurring during each occurrence of the key event, for identifying one or more longest matching patterns of the plurality of events. The processor predicts a future occurrence of the key event by determining presence of the one or more longest matching patterns of the plurality of events within a real time stream of control data.

In one aspect, the system further comprises program instructions causing the processor to provide an alarm, to an operator, indicating the future occurrence of the key event.

In one aspect, the system further comprises program instructions causing the processor to receive an input, from the operator, for performing one or more operations to prevent the future occurrence of the key event.

In one aspect, the control data is filtered based on a predefined time window associated with the start time of the key event. The predefined time window has a pre-occurrence time period and a post-occurrence time period associated with the key event.

In one aspect, the system further comprises program instructions causing the processor to identify a predefined number of predominantly occurring events from the one or more longest matching patterns of the plurality of events, and predict the future occurrence of the key event by determining presence of the predominantly occurring events within the real time stream of control data.

In one aspect, the matching includes creating a scoring matrix by assigning a predefined match score for every match with right position and a predefined penalty score for every gap.

In one aspect, the system further comprises program instructions causing the processor to train a data model for determining the presence of the one or more longest matching patterns of the plurality of events within the real time stream of control data.

In one aspect, the data model is trained using one or more machine learning techniques including Naïve Bayes, Random Forest, Decision Trees, Logistic Regression, and Support Vector Machines.

In one aspect, the matching is done using a fuzzy matching technique.

In one embodiment, a non-transitory computer-readable storage medium storing program instructions for predicting occurrence of key events based on occurrence of other events is described. The instructions, when executed, perform several steps including receiving event data related to a plurality of occurrences of a key event in an environment. The event data includes one or more of an occurrence identifier, a start time and an end time of each occurrence of the key event. The program instructions further perform receiving control data associated with a plurality of events occurring in the environment. The control data includes one or more of timestamps of the plurality of events, source of the plurality of events, priority of the plurality of events, location of occurrence of the plurality of events, operational state of equipment associated with the plurality of events, description of the plurality of events, and values of parameters associated with the plurality of events. The program instructions further perform filtering the control data based on the event data to identify a set of events occurring around the start time of the key event. The program instructions further perform matching, within pairs of occurrences of the key event, sequences of the set of events occurring during each occurrence of the key event, for identifying one or more longest matching patterns of the plurality of events. The program instructions further perform predicting a future occurrence of the key event by determining presence of the one or more longest matching patterns of the plurality of events within a real time stream of control data.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates an environment diagram of a system for predicting occurrence of a key event, in accordance with an embodiment of the present disclosure;

FIG. 2 illustrates a block diagram of an example computing device for predicting occurrence of a key event, in accordance with an embodiment of the present disclosure;

FIG. 3 illustrates a block diagram of a computing device comprising program instructions for predicting occurrence of a key event, in accordance with an embodiment of the present disclosure;

FIG. 4 illustrates an information processing and flow diagram for predicting occurrence of a peak of a flaring event, in accordance with an embodiment of the present disclosure;

FIG. 5 illustrates exemplary information related to peaks of a flaring event, in accordance with an embodiment of the present invention;

FIG. 6 illustrates exemplary information including sequences of control signal events having most similar events, in accordance with an embodiment of the present invention;

FIG. 7 illustrates exemplary information including sequence of control signal events having most similar events and number of peaks within which the sequence occurs, in accordance with an embodiment of the present invention;

FIG. 8 illustrates a time plot of events occurring for predicting occurrence of a key event, in accordance with an embodiment of the present invention; and

FIG. 9 illustrates a flow chart of a method of predicting occurrence of a key event, in accordance with an embodiment of the present disclosure.

### DETAILED DESCRIPTION OF THE INVENTION

The present disclosure provides a system and a method of predicting occurrence of key events based on occurrence of a plurality of events. The method includes receiving event data related to different occurrences of a key event in an environment. The key event may be understood as an event of interest whose future occurrence is required to be determined. The event data may include an occurrence identifier, a start time and an end time of each occurrence of the key event. The method also includes receiving control data associated with a plurality of events occurring in the environment. The control data may include timestamps of the plurality of events, source of the plurality of events, priority of the plurality of events, location of occurrence of the plurality of events, operational state of equipment associated with the plurality of events, description of the plurality of events, and values of parameters associated with the plurality of events.

The control data may be filtered based on the event data. The filtering would help in identification of a set of events occurring around the start time of the key event. Different pairs of occurrences of the key event may be made. Within the pairs of occurrences of the key event, sequences of the set of other events occurring during each occurrence of the key event are matched. Through such matching, one or more longest matching patterns of the plurality of events are identified. Thereafter, presence of the one or more longest matching patterns of the plurality of events is identified within a real time stream of control data. The presence of the one or more longest matching patterns of the plurality of events within the real time stream of control data signifies the future occurrence of the key event.

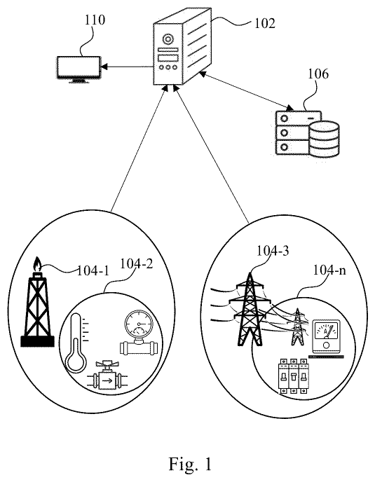

FIG. 1 illustrates an environment diagram of a system 102 for predicting occurrence of a key event i.e. an event whose occurrence is required to be predicted. The system 102 may be a data processing device such as a server. The server may be installed locally or implemented over a cloud network. The system 102 may be connected with several sensors 104-1 to 104-n (collectively referred as sensors 104) present at different locations for monitoring data related to operation of machineries. The system 102 may also be connected with a database 106 responsible for storing data related to operation of the machineries.

From the sensors 104 or the database 106, the system 102 receives event data i.e. information related to past occurrences of the key event. The event data may include an occurrence identifier (ID), a start time and an end time of each occurrence of the key event. The system 102 also receives control data associated with a plurality of events occurring in the environment. The control data includes one or more of timestamps of the plurality of events, source of the plurality of events, priority of the plurality of events, location of occurrence of the plurality of events, operational state of equipment associated with the plurality of events, description of the plurality of events, and values of parameters associated with the plurality of events.

In one scenario, the key event may be a flaring event and the plurality of events may include the events occurring within a same environment where the flaring event occurs, such as a petroleum refinery. The plurality of events may be related or non-related to the flaring event. For example, the plurality of events may include mechanical failure like malfunction of compressors and pumps, electrical failure like malfunction of generator and power distribution network, malfunction of data communication unit, and unusual values of sensors like pressure sensor, temperature sensor, and valve position sensor installed in the environment.

The system 102 filters the control data based on the event data. In one implementation, the control data may be filtered for identification of a set of events occurring around the start time of the key event. For example, the plurality of events occurring 5 minutes before occurrence of the key event may be filtered.

Successively, the system 102 may form different pairs of occurrences of the key event. For example, a first pair may be made between a first occurrence and a third occurrence of the key event, and a second pair may be made between a second occurrence and a fifth occurrence of the key event. Within each pair of occurrences of the key event, sequences of the set of events occurring during each occurrence of the key event may be matched. The matching may be performed using a fuzzy matching technique, for example Smith Waterman algorithm. Through such matching, longest matching patterns of the plurality of events may be identified. A fixed number of top other events may be separated from the longest matching patterns. For example, top 5 other events may be separated from 10 matching patterns of the other events. Such top other events may denote predominantly occurring other events of all the plurality of events.

The system 102 analyses a real time stream of control data for determining presence of the longest matching patterns of the plurality of events i.e. the predominantly occurring events. In one embodiment, the system 102 may utilize machine learning/data models for determining presence of the longest matching patterns within the real time stream of control data. The data model may be trained using different machine learning techniques, such as Naïve Bayes, Random Forest, Decision Trees, Logistic Regression, and Support Vector Machines.

With detection of the longest matching patterns, it is determined that the key event is about to occur. The system 102 may indicate to an operator, via a user device 110 connected with the system 102, that the key event is about to occur. The user device 110 may refer to any device including at least one User Interface. A non-exhaustive list of the user device 110 may include a smartphone, desktop, laptop, tablet, phablet, speaker, Light Emitting Diode (LED)/Liquid Crystal Display (LCD) display.

The UI of the user device 110 may be a Graphical User Interface (GUI). The GUI may use visual elements like windows, icons, and buttons to interact with the operator. Alternatively, the UI of the user device 110 may be a Command-Line Interface (CLI). The CLI may allow the operator to interact with the user device 110 through text-based commands. The UI of the user device 110 may be a Voice User Interface (VUI). The VUI may enable interaction through voice commands, as seen in virtual assistants. Further, the UI of the user device 110 may be a touch interface allowing interaction through touch gestures on screens, common in mobile devices. Alternatively, the UI of the user device 110 may be a Natural Language Interface (NLI). The NLI may allow the operator to interact with the user device 110 using natural language, such as chatbots or virtual assistants.

The system 102 may also indicate an expected time of occurrence of the key event. The operator may take suitable actions for preventing occurrence of the key event. For example, in case of flaring, the suitable actions may include, but not limited to, storing the hydrocarbon stock and diverting the hydrocarbon stock to its source, such as pumping excessive natural gas back to a natural gas well.

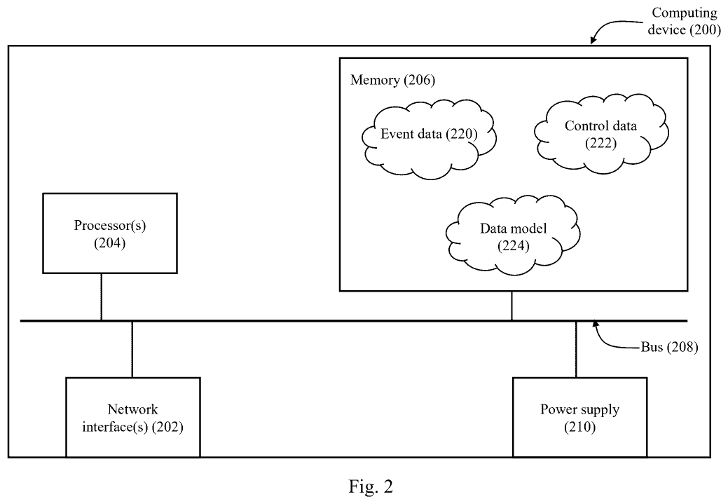

FIG. 2 illustrates a block diagram of an example computing device 200 (similar to the system 102) for predicting occurrence of a key event, in accordance with an embodiment of the present disclosure. The computing device 200 may be implemented remotely over a cloud network or locally. The computing device 200 may comprise one or more network interfaces 202 (e.g., wired, wireless, etc.), at least one processor 204, a memory 206 interconnected by a system bus 208, and a power supply 210.

The one or more network interfaces 202 may be used to provide input or fetch output from the computing device 200. The one or more network interfaces 502 may be implemented as a Command Line Interface (CLI) or a Graphical User Interface (GUI). Further, Application Programming Interfaces (APIs) may also be used for remotely interacting with edge systems and cloud servers.

The processor 204 may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

The memory 206 may include, but is not limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The memory 206 comprises a plurality of storage locations that are addressable by the processor 204 and the network interfaces 202 for storing software programs and other necessary information (event data 220, control data 222, and data model 224) associated with the embodiments described herein. The processor 204 may comprise hardware elements or hardware logic adapted to execute the software programs and manipulate data structures.

The event data 220 may correspond to information related to past occurrences of a key event. For example, the event data 220 may include an occurrence identifier (ID), a start time and an end time of each occurrence of the key event. The control data 222 may correspond to data associated with a plurality of events occurring in an environment where the key event occurs. The control data 222 may include timestamps of the plurality of events, source of the plurality of events, priority of the plurality of events, location of occurrence of the plurality of events, operational state of equipment associated with the plurality of events, description of the plurality of events, and values of parameters associated with the plurality of events. The data model 224 may correspond to Machine Learning (ML) model developed using one or more ML techniques, such as Naïve Bayes, Random Forest, Decision Trees, Logistic Regression, and Support Vector Machines.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

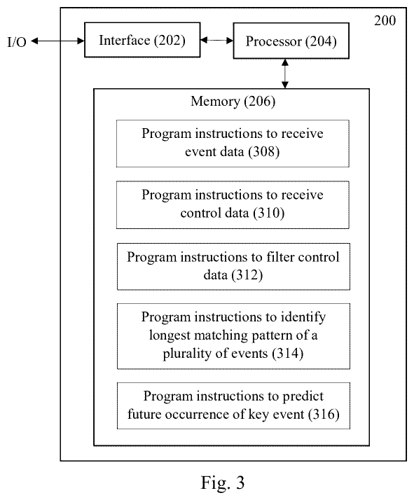

FIG. 3 illustrates a block diagram of the computing device 200 comprising program instructions for predicting occurrence of a key event, in accordance with an embodiment of the present disclosure. The memory 206 of the computing device 200 may store program instructions for performing several functions associated with prediction of the key event. Functional code stored in the memory 206 may include program instructions to receive event data 308, program instructions to receive control data 310, program instructions to filter control data 312, program instructions to identify longest matching pattern of the plurality of events 314, and program instructions to predict future occurrent of key event 316.

The program instructions to receive event data 308 may cause the processor 204 to receive event data related to a plurality of occurrences of the key event in an environment. The event data may include one or more of an occurrence identifier, a start time and an end time of each occurrence of the key event, program instructions to receive control data 310 may cause the processor 204 to receive control data associated with a plurality of events occurring in the environment, wherein the control data includes one or more of timestamps of the plurality of events, source of the plurality of events, priority of the plurality of events, location of occurrence of the plurality of events, operational state of equipment associated with the plurality of events, description of the plurality of events, and values of parameters associated with the plurality of events.

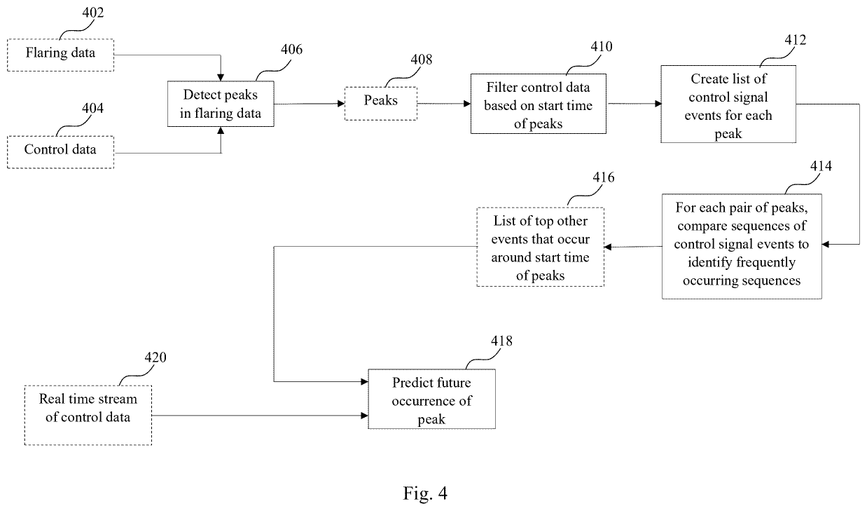

The program instructions to filter control data 312 may cause the processor 204 to filter the control data based on the event data to identify a set of events occurring around the start time of the key event. The program instructions to identify longest matching pattern of the plurality of events 314 may cause the processor 204 to match, within pairs of occurrences of the key event, sequences of the set of events occurring during each occurrence of the key event. Through such matching, the one or more longest matching patterns of the plurality of events are identified. The program instructions to predict future occurrent of key event 316 may cause the processor 204 to determine presence of the one or more longest matching patterns of the plurality of events within a real time stream of control data. When presence of the one or more longest matching patterns of the plurality of events is determined within the real time stream of control data, it is established that the occurrence of the key event is certain. A detailed explanation of the method is provided successively with reference to FIGS. 4 to 8.

FIG. 4 illustrates an information processing and flow diagram for predicting occurrence of a peak of a flaring event, in accordance with an embodiment of the present disclosure. It must be understood that a flaring event i.e. burning of excessive hydrocarbons occurs for varying time periods, such as a few minutes or hours. The peak of the flaring event refers to a time instant when a flare is longest i.e. rate of burning of the excessive hydrocarbons is highest during the flaring event. The peak of the flaring event must be understood as a key event for present embodiment, and the description henceforth must be construed accordingly.

At beginning of a process of detecting the peak of the flaring event, flaring data 402 (a type of the event data 220) and control data 404 (similar to the control data 222) are obtained. The flaring data 402 and the control data 404 may be obtained from a database or collected in real time using sensors connected with the machines/units.

In one implementation, visual inspection techniques may be used for collecting the flaring data 402. Visual inspection may be performed using Closed Circuit Television (CCTV) cameras positioned around flaring systems. Alternatively, thermal imaging cameras may be used to detect infrared radiation and measure heat emitted during flaring. The thermal imaging cameras monitor temperature of flare stack and surrounding areas to detect and quantify flare events. The thermal imaging cameras are useful for detecting and measuring the intensity of flares, even in low-light conditions.

In another implementation, spectroscopic analysis using spectroscopic sensors may be performed for collecting the flaring data 402. The spectroscopic sensors refer to Instruments used for analysis of light spectrum emitted by flares. Spectroscopic analysis identifies specific gases and compounds in the flare's emissions. Spectroscopic analysis provides detailed information about the composition of the flare and helps in assessing environmental impact.

In another implementation, gas detectors may be used for collecting the flaring data 402. Gas detectors are sensors that measure concentration of gases such as methane, ethane, and propane around the flare stack. Gas detectors help in monitoring gas emissions and ensure they fall within regulatory limits. Alternatively or additionally, flame detectors may be used for collecting the flaring data 402. The flame detectors may include optical sensors that detect the presence of flames. The flame detectors may be infrared or ultraviolet sensors used for detecting light emitted by flames.

In another implementation, remote sensing may be used for collecting the flaring data 402. Remote sensing may be performed using satellites equipped with sensors to detect thermal and infrared emissions. The satellites capture data on thermal emissions from flare stacks and analyze them to detect flaring. The satellites provide a broad view and can be used to monitor multiple sites from space. Alternatively, remote sensing may be performed using drones i.e. Unmanned aerial vehicles (UAVs) equipped with cameras and sensors. The drones fly over facilities to capture images and sensor data related to flaring.

In another implementation, acoustic monitoring may be done for collecting the flaring data 402. Acoustic monitoring may involve usage of acoustic sensors to detect sound produced by flares. The acoustic sensors analyze acoustic signals emitting from flare stacks to identify characteristic sounds of flaring, and provide supplementary information that can help in detection of flare events in noisy environments.

In another implementation, real time monitoring and control systems may be used for collecting the flaring data 402. The real time monitoring and control systems are integrated systems that monitor various parameters such as pressure, temperature, and gas flow rates. Such systems use data from sensors and control devices to detect abnormal conditions that may lead to flaring.

In another implementation, Supervisory Control and Data Acquisition (SCADA) systems may be used for collecting the flaring data 402. SCADA systems are typically used for monitoring and controlling industrial processes. SCADA systems collect data from sensors and control devices, offering real-time insights into flare operations.

The control data 404 may refer to data associated with machines/units operation in an environment where the flaring event is occurring. For example, such machines/units may include a power generation unit, power distribution unit, temperature management unit, and data communication unit.

The flaring data 402 and the control data 404 may be collected, transformed, and/or stored into one or more of the below mentioned formats. The flaring data 402 and the control data 404 may be stored as analog data i.e. continuous data represented by varying voltages or currents, corresponding to physical measurements. Analog data is capable of representing a wide range of values with high precision, and provides continuous, real-time data. Analog data may be collected from temperature sensors, pressure sensors, and other physical measurement sensors.

Alternatively or additionally, the flaring data 402 and the control data 404 may be stored as digital data. Digital Data refers to discrete data represented in binary format (0s and 1s). Digital noise includes less noise and interference compared to analog data. Digital data is captured from digital temperature sensors, pressure sensors, and other sensors that convert analog signals into digital format.

Alternatively or additionally, the flaring data 402 and the control data 404 may be stored as structured data. Structured data refers to data organized in a predefined format, such as tables or databases, making it easy to query and analyze. Structured data provides several benefits including easy readability and management with standard data tools and software, easy integration with databases and analytics platforms, and structured querying and reporting. For example, the structured data may be present as Comma-Separated Values (CSV), JavaScript Object Notation (JSON), or extensible Markup Language (XML) format.

Alternatively or additionally, the flaring data 402 and the control data 404 may be stored as unstructured data. Unstructured data refers to data that does not follow a specific format or structure, often in the form of free text or multimedia. Unstructured data provides several benefits including capturing detailed and diverse types of information that structured data may miss and adaptability to various types of data, including raw sensor outputs. For example, the unstructured data may be present as text files, images, audio files, or video files.

Alternatively or additionally, the flaring data 402 and the control data 404 may be stored as time-series data. Time-series data refers to data collected sequentially over time, representing changes or trends in sensor readings. Time-series data allows performing trend analysis and temporal context analysis. Time-series data may be stored as time-stamped Comma-Separated Values (CSV) or JavaScript Object Notation (JSON) format.

Alternatively or additionally, the flaring data 402 and the control data 404 may be stored as geospatial data. Geospatial data refers to data with geographic or spatial components, often including coordinates and other location-related information. Geospatial data may be present in Global Positioning System (GPS) coordinates, GeoJSON, shapefiles, or Keyhole Markup Language (KML) format. Geospatial data enables mapping and spatial analysis, providing context related to geographic locations.

Alternatively or additionally, the flaring data 402 and the control data 404 may be stored as hierarchical data. Hierarchical data refers to data organized in a tree-like structure with nested levels of information, and represents complex relationships and nested data in an organized manner. Hierarchical data may be present in JSON or XML format.

Alternatively or additionally, the flaring data 402 and the control data 404 may be stored as streaming data. Streaming data refers to data that is continuously generated and transmitted in real-time, often used for real-time analytics. Streaming data enables immediate analysis and response to incoming data. Streaming data may be present as data streams, Message Queuing Telemetry Transport (MQTT), or Apache Kafka streams.

At block 406, the flaring data 402 is processed to detect peaks 408. The peaks 408 may be detected using different techniques. For example, when the flaring data 402 is present as temperature values, the peaks 408 may be detected using data filtering techniques. Alternatively, when the flaring data 402 is present as images, the peaks 408 may be detected using image processing techniques. Detecting the peaks 408 in images involves identifying regions having sharp increase in intensity, which may correspond to bright or prominent features.

In one implementation, before detection of the peaks 408, a pre-processing step may be performed. During the pre-processing step, coloured images are converted into grayscale images for reducing the coloured images to a single channel when colour information is not necessary. Parameters like average, weighted average, or luminosity may be determined for performing the conversion. Further, during the pre-processing step, noise reduction may be performed for improving detection accuracy by smoothing out noise. Techniques like Gaussian blur or median filter may be applied for noise reduction.

Successively, feature enhancement may be performed. Feature enhancement may involve performing contrast enhancement to make the peaks stand out more clearly from background content. Techniques like histogram equalization or contrast stretching may be used for performing contrast enhancement. Feature enhancement may also involve performing edge detection for identifying sharp changes in intensity that are indicative of the peaks. Edge detection algorithms such as Sobel, Canny, or Prewitt may be used for this purpose.

Thereafter, the peaks 408 may be detected by performing different operations, such as thresholding, local maxima detection, and morphological operations. Thresholding operation may be performed for identifying regions with intensity values above a certain threshold. Local maxima detection may be performed for identifying local peaks in an intensity profile. Local maxima detection may be performed using neighborhood analysis or peak-finding algorithms. Morphological operations may be performed for refining detected peaks and remove small artifacts.

The detected peaks 408 may be subjected to refinement and analysis. For example, connected component analysis may be done for grouping pixels into connected regions for analyzing size and shape of detected peaks. Further, filtering and validation may be done to filter out false positives and validate the detected peaks. Further, peak characterization may be done to analyze properties of the detected peaks, e.g., size, intensity, shape.

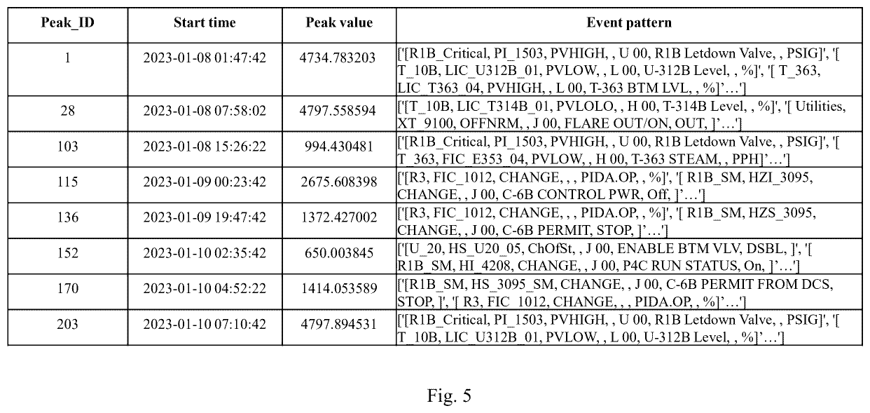

For each of the peaks 408, associated information, such as an occurrence identifier (peak_ID), peak value, start time, and an end time may also be recorded. An exemplary illustration of the information related to the peaks 408 is provided in FIG. 5. For example, for a peak having peak ID “1”, an occurrence date and start time (cumulatively referred as start time) of “2023-01-08 01:47:42”, peak value “4734.783203” and an event pattern “[R1B_Critical, PI_1503, PVHIGH, U 00, R1B Letdown Valve, PSIG]’, ‘[T_10B, LIC_U312B_01, PVLOW, L 00, U-312B Level, %]’, ‘[T_363, LIC_T363_04, PVHIGH, L 00, T-363 BTM LVL, %]’ . . . ’]” is recorded. The event pattern includes details of different events that occurred during occurrence of the peak having the peak ID “1”. Similarly, for other peaks, associated information may be stored.

At block 410, the control data 404 may be filtered based on the start time of the peaks 408. Such filtering helps in identification of a plurality of events (referred hereafter as other events) that occur around occurrence of the peaks 408. Based on the filtering, a list of control signal events may be created for each peak, at block 412. The control signal events refer to the other events occurring around the occurrence of the peaks 408. For example, the control data 404 may be filtered based on the start time “2023-01-08 01:47:42” of the peak having the peak ID “1”. Through such filtering, a portion of the control data 404 that was captured on date 2023 Jan. 8 around the time 01:47:42 may be identified and stored separately.

At block 414, different pairs of the peaks 408 may be formed. In one implementation, pairs of the peaks 408 may be formed randomly. For each pair of the peaks 408, sequences of the control signal events may be compared. From comparison of the sequences of the control signal events, longest matching patterns (alternatively referred as frequently occurring sequences) of the other events could be identified.

In one implementation, the sequences of the control signal events may be compared using a fuzzy matching technique, such as Smith-Waterman algorithm. Using the fuzzy matching technique may involve creating a scoring matrix. For creating the scoring matrix, a user defined match score i.e. an input to a matrix algorithm may be defined for every match with right position. Further, a penalty may be defined for every gap corresponding to a wrong position. Also, a user defined argument i.e. a variable passed to a function may be set. For example, for below mentioned input sequences

$$a = {{[}^{{}_{‘}} [ h ]}^{{}_{’}} , ‘ {[ a ]}^{{}_{’}} , ‘ {[ p ]}^{{}_{’}} , ‘ {[ p ]}^{{}_{’}} , ‘ {[ y ]}^{{}_{’}} ] \\ b = [ ‘ {[ a ]}^{{}_{’}} , ‘ {[ p ]}^{{}_{’}} , ‘ {[ y ]}^{{}_{’}} ] ,$$

where a match score of 3 and a gap penalty of 2 is defined, an output matrix as provided below could be generated.

| | | a | p | y |
|---|---|---|---|---|
| | 0 | 0 | 0 | 0 |
| h | 0 | 0 | 0 | 0 |
| a | 0 | 3 | 1 | 0 |
| p | 0 | 1 | 6 | 4 |
| p | 0 | 0 | 4 | 3 |
| y | 0 | 0 | 2 | 7 |

Successively, a traceback function could be used for finding maximum alignment. Starting from right bottom corner, an event with a highest score is checked, and a longest common sequence of events is identified. Such task is performed using a recursive function, until row 0 is reached.

The above provided output matrix includes the below values.

$$[ [ \begin{matrix}0 & 0 & 0 & 0\end{matrix} ] \\ [ \begin{matrix}0 & 0 & 0 & 0\end{matrix} ] \\ [ \begin{matrix}0 & 3 & 1 & 0\end{matrix} ] \\ [ \begin{matrix}0 & 1 & 6 & 4\end{matrix} ] \\ [ \begin{matrix}0 & 0 & 4 & 3\end{matrix} ] \\ [ \begin{matrix}0 & 0 & 2 & 7\end{matrix} ] ]$$

From the above, it could be observed that between “y” event at max value 7 and “y” event at max value 6 has a gap row of 1. Hence, the below matrix could be produced as a result.

$$[ [ \begin{matrix}0 & 0 & 0\end{matrix} ] \\ [ \begin{matrix}0 & 0 & 0\end{matrix} ] \\ [ \begin{matrix}0 & 3 & 1\end{matrix} ] \\ [ \begin{matrix}0 & 1 & 6\end{matrix} ] \\ [ \begin{matrix}0 & 0 & 4\end{matrix} ] ]$$

Successively, comparing “p” event at max value 6 and an “a” event at max value 3, the below matrix could be obtained.

$$[ [ \begin{matrix}0 & 0 ]\end{matrix} \\ [ \begin{matrix}0 & 0 ]\end{matrix} \\ [ \begin{matrix}0 & 3 ]\end{matrix} ]$$

From the above-mentioned matrix, an output [‘[a]’, ‘[p]’, ‘-’, ‘[y]’] is obtained.

Similarly, other fuzzy matching techniques could also be implemented. For4 example, an edit distance algorithm based on Levenshtein distance or Damerau-Levenshtein distance may be used. Alternatively, a similarity metrics may be developed using Jaro-Winkler distance or cosine similarity. Further, token-based matching may be performed using Jaccard similarity. Also, N-gram analysis, or Regex-based matching may be done.

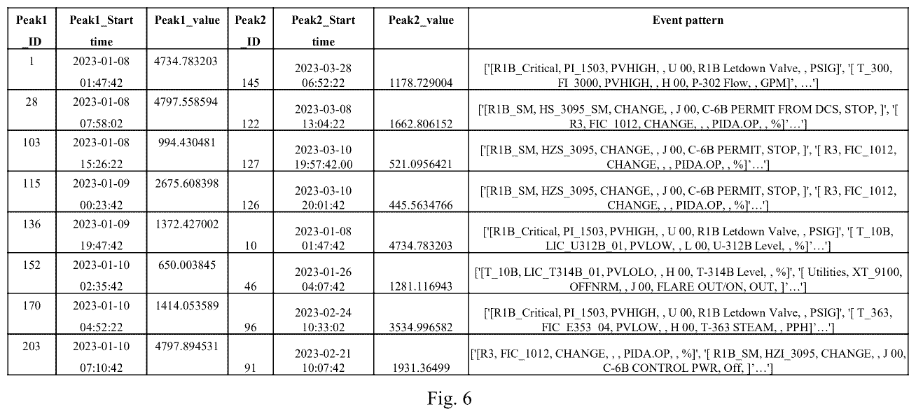

Using any of the fuzzy matching techniques mentioned above, the information illustrated in FIG. 5 could be processed. Specifically, the sequences of the control signal events may be compared for determining sequences of control signal events having most similar events, as illustrated in FIG. 6. For example, as shown in second row of FIG. 6, by comparing the sequence of control signal events corresponding to the peak ID 1 and the peak ID 145, a sequence [‘[R1B_Critical, PI_1503, PVHIGH, U 00, R1B Letdown Valve, PSIG]’, ‘[T_300, FI_3000, PVHIGH, H 00, P-302 Flow, GPM]’, . . . ’] is identified as the sequence of control signal events having most similar events. Similarly, the comparison may be performed for different peaks.

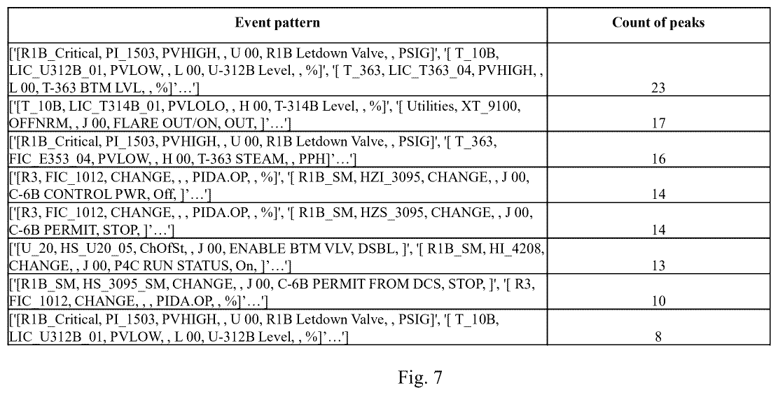

For each sequence of control signal events having most similar events, number of peaks within which the sequence occurs is determined. An example form of such information is illustrated in FIG. 7. For example, as illustrated in second row of FIG. 7, the event pattern (sequence of control signal events) [‘[R1B_Critical, PI_1503, PVHIGH, U 00, R1B Letdown Valve, PSIG]’, ‘[T_10B, LIC_U312B_01, PVLOW, L 00, U-312B Level, %]’, ‘[T_363, LIC_T363_04, PVHIGH, L 00, T-363 BTM LVL, %]’ . . . ’] is identified to be present within 23 peaks. Such sequences of control signal events denote frequently occurring sequences.

Referring back to FIG. 4, in case multiple frequently occurring sequences are identified, certain number of top other events 416 may be separated based on a predefined threshold. For example, a list of top three other events that occur around the start time of the peaks 408 may be maintained. With reference to FIG. 7, it may be understood that the top three event patterns identified to be present within 23, 17, and 16 peaks may be identified as the top other events 416.

At block 418, future occurrence of a peak may be predicted by processing a real time stream of control data 420 based on the top other events 416. Specifically, presence of the top other events 416 may be determined within a prediction window (of predefined time duration) of the real time stream of control data 420, for predicting the future occurrence of the peak. For example, presence of the top other events 416 may be checked within a 5-minute prediction window of the real time stream of control data 420, for predicting the future occurrence of the peak. When presence of the top other events 416 is confirmed to be present within the prediction window, it may be affirmed that a new peak of the flaring event is imminent.

Post prediction, details of the new peak of the flaring event may be provided to an operator, such as an engineer or a technician. The details may also indicate an expected time of occurrence of the new peak of flaring. The operator may take suitable actions to prevent occurrence of the new peak of flaring. For example, the suitable actions may include, but not limited to, storing the hydrocarbon stock into tankers, diverting the hydrocarbon stock to its source, such as pumping excessive natural gas back to a natural gas well.

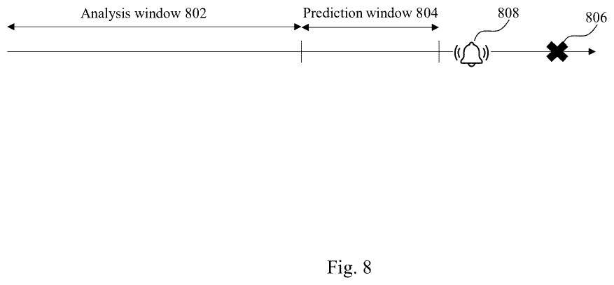

FIG. 8 illustrates a time plot of events occurring for predicting occurrence of a key event, in accordance with an embodiment of the present invention. An analysis window 802 corresponds to a time period during which the steps described at block 406 (detecting peaks in flaring data), block 410 (filtering control data based on start time of the peaks), block 412 (creating a list of control signal events for each peak), and block 414 (for each pair of the peaks, comparing sequences of control signal events to identify frequently occurring sequences) are performed. During a prediction window 804, future occurrence of a peak is predicted by determining presence of one or more other events within a real time stream of control data. When it is predicted that a new peak of the flaring event is imminent at time instance 806, an alert is provided to an operator at time instance 808. Based on the alert, the operator may take suitable actions to prevent occurrence of the new peak of flaring at the time instance 806.

In one or more implementations, Machine Learning (ML) models may be developed using a supervised or unsupervised ML technique. Development of the ML model would essentially involve the below described stages.

First stage involves data preparation. Data preparation involves profiling, formatting, and structuring data to make the data ready for training the ML model. Further, the data is pre-processed by normalizing, eliminating duplicates, and making error corrections. At this stage, appropriate characteristics and attributes of the data are selected. This stage has a direct impact on execution time and results of the ML model. Also, at this stage, data is categorized into two groups-one for training the ML model (known as training dataset) and the other for evaluating the model (known as testing dataset).

Second stage involves training the ML model. At this stage, an ML model/algorithm is trained upon the training dataset. Consistent training significantly improves the prediction rate of the ML model. At this stage, weights of the ML model are initialized randomly, and the ML model learns to adjust the weights accordingly.

Third stage involves evaluating performance of the ML model. At this stage, the ML model is tested against the testing dataset for assessing performance of the ML model. For ML models trained for classification tasks, metrics used for evaluating performance of the ML models include accuracy, precision, recall, F1-score, Area Under the Receiver Operating Characteristic curve (AUC-ROC), and confusion metrics.

Fourth stage involves parameter tuning of the ML model. Selecting a correct parameter that will be modified to influence the ML model is key to attaining accurate correlation. The set of parameters that are selected based on their influence on the ML model architecture are called hyperparameters. The process of identifying the hyperparameters by tuning the model is called parameter tuning. The parameters for correlation should be clearly defined in a manner in which the point of diminishing returns for validation is as close to 100% accuracy as possible.

In the above described manner, different ML techniques including Logistic regression, decision trees, random forests, support vector machines, k-nearest neighbours, naïve Bayes, and neural networks could be used for developing the ML model. Once trained and validated, the ML model may be used for predicting future occurrence of a key event by determining presence of longest matching patterns of other events within a real time stream of control data.

When an alert indicating a future occurrence of a key event is provided to an operator, the operator may take one or more suitable actions for preventing occurrence of the key event or mitigating adverse effects due to occurrence of the key event. For example, in case of flaring, maintenance of equipment such as pressure relief valves, rupture disks, pressure safety valves, and basic control valves can be performed. Alternatively, storage or flow diversion of hydrocarbon fuel can be performed to prevent the flaring event. Such actions would allow the oil and gas producers, refineries, and petrochemical facilities to reduce flaring events and recover waste gases, to meet Net Zero Flaring and Net Zero Emissions.

It must be understood that the above description has been provided with reference to flaring only as an example. The same methodology, without any modification or with minor modifications, could be implemented for other applications for preventing occurrence of other key events or to reduce detrimental effect due to occurrence of the other key events. A non-limiting list of the other key events may include natural calamities like cyclones, flooding, and earthquake, and different industrial processes.

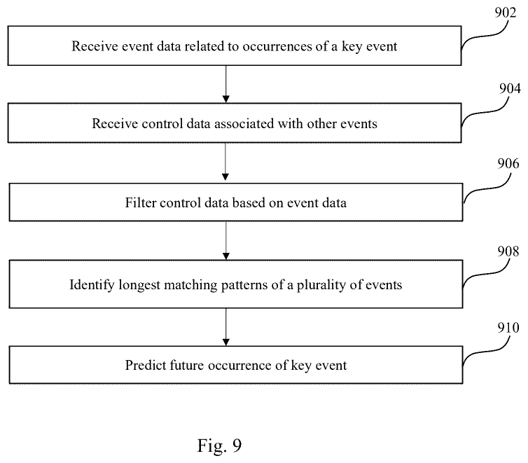

FIG. 9 illustrates a flow chart of a method of predicting occurrence of a key event, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 9 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

At step 902, event data related to a plurality of occurrences of a key event in an environment is received. The key event refers to an event whose occurrence is required to be predicted, such as flaring, flooding, etc. The event data may be received from sensors installed in the environment or a database storing information collected from the sensors. The event data includes one or more of an occurrence identifier (ID), a start time and an end time of each occurrence of the key event.

At step 904, control data associated with a plurality of events occurring in the environment is received. The plurality of events may be related or unrelated to the key event. The control data includes one or more of timestamps of the plurality of events, source of the plurality of events, priority of the plurality of events, location of occurrence of the plurality of events, operational state of equipment associated with the plurality of events, description of the plurality of events, and values of parameters associated with the plurality of events.

At step 906, the control data is filtered based on the event data to identify a set of events occurring around the start time of the key event. The control data may be filtered based on a timestamp of the key event. For example, the control data retrieved for a 5 minute duration (3 minutes before the key event and 3 minutes after the key event) may be filtered for identifying the set of events.

At step 908, sequences of the set of other events occurring during each occurrence of the key event are matched within different pairs of occurrences of the key event. The pairs of occurrences of the key event may be formed randomly. Further, the matching may be performed using a fuzzy matching technique, for example Smith Waterman algorithm. Based on the matching, one or more longest matching patterns of the plurality of events are identified.

At step 910, a future occurrence of the key event is predicted by determining presence of the one or more longest matching patterns of the plurality of events within a real time stream of control data. In some implementations, machine learning/data models may be used for determining presence of the longest matching patterns (also referred as predominantly occurring other events) within the real time stream of control data. The data model may be trained using different machine learning techniques, such as Naïve Bayes, Random Forest, Decision Trees, Logistic Regression, and Support Vector Machines.

Through detection of the longest matching patterns, it is predicted that the key event is about to occur. An alert may be provided to an operator, via a user device such as a smartphone, that the key event is about to occur. The operator may also be informed about an expected time of occurrence of the key event. Based on such alert, the operator may take suitable actions for preventing occurrence of the key event.

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

Those skilled in the art will understand that any number of nodes, devices, links, etc. may be used in the cloud network, and that the view shown herein is for simplicity. Also, those skilled in the art will further understand that while the cloud network is shown in a certain orientation, the cloud network is merely an example illustration that is not meant to limit the disclosure. For example, “real-world” cloud networks may comprise any type of network, including, among others, Fog networks, IoT networks, core networks, backbone networks, data centers, enterprise networks, provider networks, customer networks, virtualized networks (e.g., virtual private networks or “VPNs”), combinations thereof, and so on. Note further that the network environments and their associated devices may also be located in different geographic locations.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

1. A method comprising:
receiving event data related to a plurality of occurrences of a key event in an environment, wherein the event data includes one or more of an occurrence identifier, a start time and an end time of each occurrence of the key event;
receiving control data associated with a plurality of events occurring in the environment, wherein the control data includes one or more of timestamps of the plurality of events, source of the plurality of events, priority of the plurality of events, location of occurrence of the plurality of events, operational state of equipment associated with the plurality of events, description of the plurality of events, and values of parameters associated with the plurality of events;
filtering the control data based on the event data to identify a set of events occurring around the start time of the key event;
matching, within pairs of occurrences of the key event, sequences of the set of events occurring during each occurrence of the key event, for identifying one or more longest matching patterns of the plurality of events; and
predicting a future occurrence of the key event by determining presence of the one or more longest matching patterns of the plurality of events within a real time stream of control data.

2. The method as claimed in claim 1, further comprising providing an alarm, to an operator, indicating the future occurrence of the key event.

3. The method as claimed in claim 2, further comprising receiving an input, from the operator, for performing one or more operations to prevent the future occurrence of the key event.

4. The method as claimed in claim 1, wherein the control data is filtered based on a predefined time window associated with the start time of the key event.

5. The method as claimed in claim 4, wherein the predefined time window has a pre-occurrence time period and a post-occurrence time period associated with the key event.

6. The method as claimed in claim 1, further comprising:
identifying a predefined number of predominantly occurring events from the one or more longest matching patterns of the plurality of events; and
predicting the future occurrence of the key event by determining presence of the predominantly occurring events within the real time stream of control data.

7. The method as claimed in claim 1, wherein the matching includes creating a scoring matrix by assigning a predefined match score for every match with right position and a predefined penalty score for every gap.

8. The method as claimed in claim 1, further comprising training a data model for determining the presence of the one or more longest matching patterns of the plurality of events within the real time stream of control data.

9. The method as claimed in claim 8, wherein the data model is trained using one or more machine learning techniques including Naïve Bayes, Random Forest, Decision Trees, Logistic Regression, and Support Vector Machines.

10. The method as claimed in claim 1, wherein the key event is one of flaring and flooding.

11. A system comprising:
a processor; and
a memory storing program instructions which, when executed by the processor, causes the processor to:
receive event data related to a plurality of occurrences of a key event in an environment, wherein the event data includes one or more of an occurrence identifier, a start time and an end time of each occurrence of the key event;
receive control data associated with plurality of events occurring in the environment, wherein the control data includes one or more of timestamps of the plurality of events, source of the plurality of events, priority of the plurality of events, location of occurrence of the plurality of events, operational state of equipment associated with the plurality of events, description of the plurality of events, and values of parameters associated with the plurality of events;
filter the control data based on the event data to identify a set of events occurring around the start time of the key event;
match, within pairs of occurrences of the key event, sequences of the set of events occurring during each occurrence of the key event, for identifying one or more longest matching patterns of the plurality of events; and
predict a future occurrence of the key event by determining presence of the one or more longest matching patterns of the plurality of events within a real time stream of control data.

12. The system as claimed in claim 11, further comprises program instructions causing the processor to provide an alarm, to an operator, indicating the future occurrence of the key event.

13. The system as claimed in claim 12, further comprises program instructions causing the processor to receive an input, from the operator, for performing one or more operations to prevent the future occurrence of the key event.

14. The system as claimed in claim 11, wherein the control data is filtered based on a predefined time window associated with the start time of the key event, and wherein the predefined time window has a pre-occurrence time period and a post-occurrence time period associated with the key event.

15. The system as claimed in claim 11, further comprises program instructions causing the processor to:
identify a predefined number of predominantly occurring events from the one or more longest matching patterns of the plurality of events; and
predict the future occurrence of the key event by determining presence of the predominantly occurring events within the real time stream of control data.

16. The system as claimed in claim 11, wherein the matching includes creating a scoring matrix by assigning a predefined match score for every match with right position and a predefined penalty score for every gap.

17. The system as claimed in claim 11, further comprises program instructions causing the processor to train a data model for determining the presence of the one or more longest matching patterns of the plurality of events within the real time stream of control data.

18. The system as claimed in claim 17, wherein the data model is trained using one or more machine learning techniques including Naïve Bayes, Random Forest, Decision Trees, Logistic Regression, and Support Vector Machines.

19. The system as claimed in claim 11, wherein the matching is done using a fuzzy matching technique.

20. A non-transitory computer-readable storage medium storing program instructions, the instructions, when executed, perform the steps of:
receiving event data related to a plurality of occurrences of a key event in an environment, wherein the event data includes one or more of an occurrence identifier, a start time and an end time of each occurrence of the key event;
receiving control data associated with plurality of events occurring in the environment, wherein the control data includes one or more of timestamps of the plurality of events, source of the plurality of events, priority of the plurality of events, location of occurrence of the plurality of events, operational state of equipment associated with the plurality of events, description of the plurality of events, and values of parameters associated with the plurality of events;
filtering the control data based on the event data to identify a set of events occurring around the start time of the key event;
matching, within pairs of occurrences of the key event, sequences of the set of events occurring during each occurrence of the key event, for identifying one or more longest matching patterns of the plurality of events; and
predicting a future occurrence of the key event by determining presence of the one or more longest matching patterns of the plurality of events within a real time stream of control data.
